(19) United States
(12) Patent Application Publication
(10) Pub. No.: US 2012/0280586 A1
(43) Pub. Date: Nov. 8, 2012

(54) PERMANENT MAGNET COUPLING

(76) Inventors: Thomas Englert, Grossostheim (DE); Thomas Moka, Roedermark (DE)

(21) Appl. No.: 13/520,637

(22) PCT Filed: Jan. 19, 2011
(86) PCT No.: PCT/EP2011/050639

§ 371 Date: Jul. 25, 2012

(30) Foreign Application Priority Data
Jan. 19, 2010 (DE) 20 2010 001 180.9

(51) Int. Cl. H02K 49/10

(52) U.S. Cl. 310/103

(57) ABSTRACT

The invention relates to a permanent magnet coupling for synchronously transmitting rotary motions, having a first rotor (1a) and a second rotor (1b), each covered by permanent magnets (2a, 2b) and forming an inner rotor and an outer rotor, wherein permanent magnets (2a, 2b) of the first rotor (1a) and the second rotor (1b) associated with each other extend over the same angle range in the circumferential direction. According to the invention, unfilled intermediate spaces (5) are formed on the first rotor (1a), starting from complete coverage by permanent magnets (2a) in the circumferential direction, by leaving out a portion of the permanent magnets (2a), wherein the first rotor (1a) and the second rotor (1b) comprise a different number of permanent magnets (2a, 2b).

The invention relates to a permanent-magnet coupling for the synchronous transmission of rotary movement, comprising a first rotor and a second rotor that are each covered with permanent magnets, and that form an inner rotor and an outer rotor, permanent magnets of the first rotor and of the second rotor that are associated with each other extending circumferentially across the same angle.

Permanent-magnet couplings enable the wear- and contact-free transmission of torque across the air gap. The term air gap relates to the gap formed between the rotors in which, for example, a containment shell can be provided that makes possible a leak-free seal between inner rotor and outer rotor. Permanent-magnet couplings having a containment shell can thus be employed, for example, in pumps so as to ensure enhanced safety through the leak-free transmission of torque even for environmentally damaging, toxic, or otherwise hazardous materials due to their physical separation.

In addition, permanent-magnet couplings provide wear-free torque limitation in that the inner rotor and the outer rotor move synchronously and the permanent-magnet coupling slips once it has reached the specified limit value. These properties are advantageous especially in the case of production and processing machines whenever, for example, the purpose is to prevent overloading, or to maintain a specified tightening torque when producing a screw-type connection. Since the transmission of the torque is effected in a without contact, slippage during proper operation does not result in any wear to the coupling, with the result that the coupling is basically well suited for long-term use under severe load.

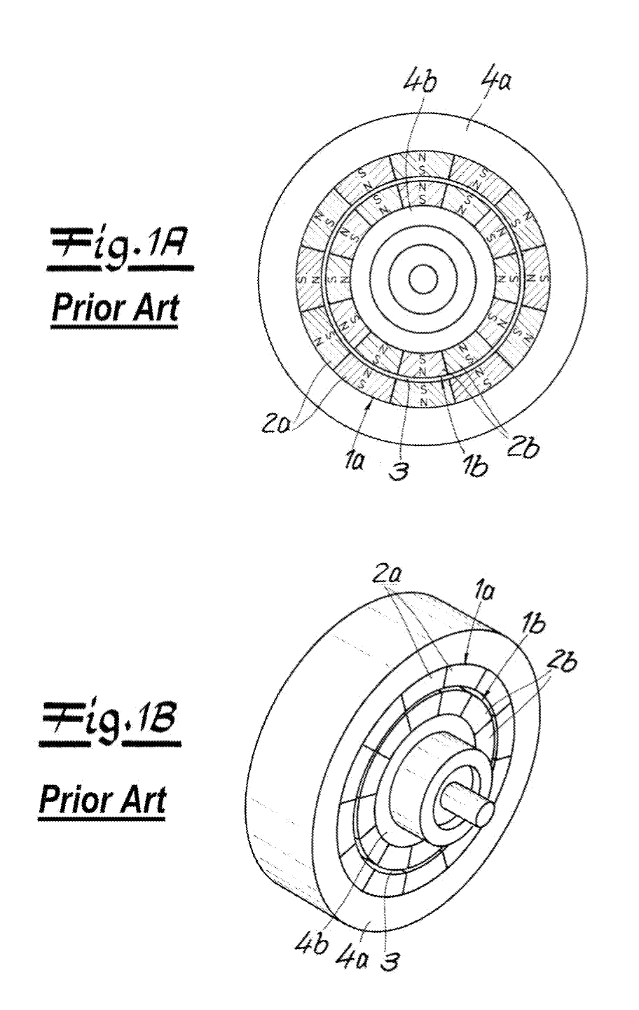

This invention is based on a permanent-magnet coupling known in practice, the inner rotor and outer rotor of which are completely covered by permanent magnets, successively arranged permanent magnets on each of the rotors having opposite directions of magnetization (FIGS. 1a and 1b). All of the magnets extend in the same circumferential direction, that is, cover the same angle. In terms of magnetic forces between inner rotor and outer rotor, a minimum value results when at the air gap each south pole of the outer rotor opposes a respective north pole of the inner rotor, and each north pole of the outer rotor opposes a respective south pole of the inner rotor. The individual permanent magnets can have a curved shape such that the permanent magnets of the outer rotor are correspondingly larger due to their expanded diameter. A high level of torque can be transmitted with a compact construction due to the dense packing of mutually aligned permanent magnets. The permanent magnets of the inner and outer rotor are each provided on a rotor support that is also provided as a return path element for magnetic flux. Once the maximum torque to be transmitted has been attained, the coupling slips, i.e. the rotor provided as the output side can no longer follow the driven rotor. The slippage is associated with a significant development of heat that increases with the duration of the slippage and the rotational speed of the permanent-magnet coupling due to the effective magnetic forces and eddy currents produced. Depending on the given construction of the permanent-magnet coupling, this results in a maximum slip duration or maximum rotational speed that restrict the range of application, which duration or speed must not be exceeded during operation so as to prevent overheating. As a result, longer-duration slippage must be avoided in the range of high rotational speeds with the known embodiments.

GB 2 240 666 A (see FIG. 1) discloses a permanent-magnet coupling in which an equidistant angular spacing is provided between adjacent permanent magnets of the outer rotor. This spacing results from the fact that the permanent magnets of the outer rotor have approximately the same angular dimension as the permanent magnets of the inner rotor. Based on the conventional approach, the same number of permanent magnets is provided on the inner rotor and the outer rotor such that during synchronous motion one permanent magnet of the outer rotor is associated with each permanent magnet of the inner rotor. The maximum torque transmitted is relatively low due to the incomplete coverage of the outer rotor.

The object of this invention is to provide a permanent-magnet coupling that has a relatively low tendency to overheat is during slippage, yet has a compact construction and high level of transmitted torque.

Based on a permanent-magnet coupling having the features described above, the object is achieved according to the invention by an approach wherein starting with complete coverage with permanent magnets in the circumferential direction on the first rotor unfilled intermediate spaces are formed by omitting a portion of the permanent magnets, and wherein the first rotor and the second rotor have different numbers of permanent magnets.

Since a portion of the permanent magnets is omitted in the circumferential direction on the first rotor, during synchronous transmission of rotary movement a permanent magnet of the first rotor is no longer associated with each permanent magnet of the second rotor that is preferably completely covered in the circumferential direction with permanent magnets. Due to the omission of a portion of the permanent magnets, the maximum transmitted torque is reduced to a certain extent. Surprisingly, however, the creation of unfilled intermediate spaces causes the thermal load during slippage to be very greatly reduced. This is because alternation of permanent magnets and unfilled intermediate spaces on the first rotor cause strong eddy currents and movements of air to be generated that enable very effective cooling to be achieved by distributing and dissipating heat when the permanent-magnet coupling slips, i.e. during slippage. Overheating can thus be prevented during continuous slippage even in comparison with the significantly increased rotational speeds of the prior art, thereby yielding a significantly longer service life for the permanent-magnet coupling under extreme conditions.

As is the case with the embodiment known from practical use, all of the magnets advantageously have the same angular dimension in the circumferential direction, that is, they cover the same angle. The magnets are generally also of different sizes due to the different diameters of the inner rotor and outer rotor. The concept of complete coverage within the scope of the invention also is still understood to refer to embodiments in which a small intermediate space or intermediate segment still remains between adjacent magnets. An intermediate segment can be provided, in particular, for the purpose of securely retaining the permanent magnets. In the case of an arcuate shape for the magnets corresponding to the curvature at the air gap between the first rotor and the second rotor, however, the magnets that successsively follow each other in the circumferential direction can also directly abut one another.

What is essential within the scope of the invention is that the intermediate spaces formed by omitting a portion of the magnets remain unfilled, thereby enabling the described eddy currents of air to form. The intermediate spaces extending parallel to the rotational axis and the swirling of the air enable an improved and more uniform distribution of heat to be also achieved as viewed longitudinally.

Successively arranged permanent magnets on the second rotor as viewed in the circumferential direction preferably each have an opposite direction of magnetization. All of the permanent magnets arranged successively as viewed in the circumferential direction can also each have an opposite direction of magnetization on the first rotor such that the intermediate spaces then each extend over an angle that corresponds to the angular dimension of two or at least an even number of permanent magnets of the first rotor.

Provision is made in an alternative embodiment where on the first rotor the respective adjacent permanent magnets have an identical direction of magnetization along with an otherwise alternating orientation of the permanent magnets at the intermediate spaces, such that the intermediate spaces each extend over an angle that corresponds to the angular dimension of one permanent magnet or of an odd number of permanent magnets of the first rotor.

The embodiments described thus correspond to an arrangement that is based on the known complete coverage with permanent magnets on the inner rotor and on the outer rotor, with individual permanent magnets or pairs of permanent magnets omitted with uniform spacing on one of the two rotors.

The rotor provided with unfilled intermediate spaces can form the inner rotor or the outer rotor without restriction, the unfilled intermediate spaces being advantageously provided on the respective driven rotor so as to achieve the described ventilation effect during slippage.

The following describes the invention with reference to a drawing showing only one embodiment. Therein:

FIG. 1a is schematic view of a permanent-magnet coupling according to the prior art;

FIG. 1b is a perspective view of the known permanent-magnet coupling of FIG. 1a;

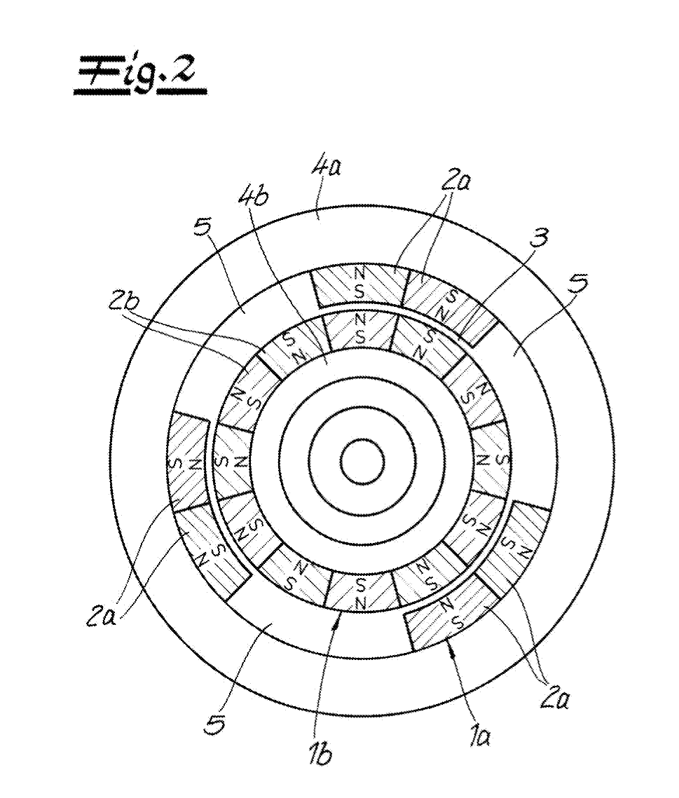

FIG. 2 through FIG. 4 shows alternative embodiments of permanent-magnet couplings according to the invention.

FIGS. 1a and 1b respectively are top and perspective views of a permanent-magnet coupling as known in the prior art. The permanent-magnet coupling comprises a first rotor 1a and a second rotor 1b that are each covered with permanent magnets 2a and 2b, and form an inner rotor and an outer rotor. The first rotor 1a and the second rotor 1b each have twelve of the permanent magnets 2a and 2b, that are arranged around the circumference with alternating directions of magnetization. The permanent magnets 2a and 2b are of arcuate shape corresponding to the curvature of an air gap 3 formed between the rotors 1a and 1b1 thereby forming essentially closed rings. The permanent magnets 2a and 2b of the first rotor 1a or of the second rotor 1b are mounted on rotor supports 4a and 4b, that are provided as return path elements for the magnetic flux.

The known permanent-magnet coupling is characterized by a high transmitted torque along with a compact construction, while nevertheless a very high development of heat is observed during slip. Since this development of heat is a function of the rotational speed, there is a danger that the permanent-magnet coupling will overheat and be damaged whenever it slips at high rotational speed for an extended period of time.

FIG. 2 is based on the known design and shows a permanent-magnet coupling according to the invention in which first rotor 1a forms the driven outer rotor. While the inner rotor is like the second rotor 1b described above, pairs of oppositely poled permanent magnets 2a with unfilled intermediate spaces 5 alternate around the circumference on the outer rotor that has a total of only six permanent magnets 2a, the intermediate spaces each extending over angle that corresponds to the dimension of two permanent magnets 2a of first rotor 1a. When the inner rotor forming the second rotor 1b can no longer follow the motion of driven first rotor 1a and the permanent-magnet coupling slips, a significant amount of heat is produced. However, strong eddy currents are generated by unfilled intermediate spaces 5 and these currents produce an effective cooling and uniform distribution of heat, thereby enabling overheating of the permanent-magnet coupling to be prevented even in the case of increased rotational speeds and/or relatively long slippage when compared with known embodiments.

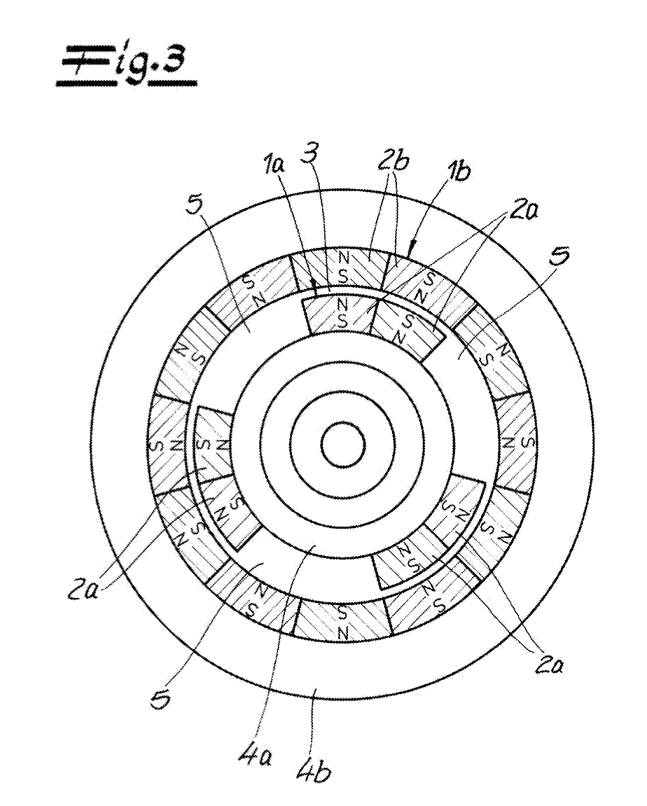

FIG. 3 shows an alternative embodiment in which, while of otherwise analogous design, the inner rotor is driven and accordingly forms the first rotor 1a of the permanent-magnet coupling according to the invention, this rotor being provided with intermediate spaces 5. In this embodiment as well, the first rotor 1a has only six permanent magnets 2a as compared with the second rotor 1b with twelve permanent magnets 2b, and the magnets of the first rotor are arranged in three groups each having two oppositely oriented permanent magnets 2a.

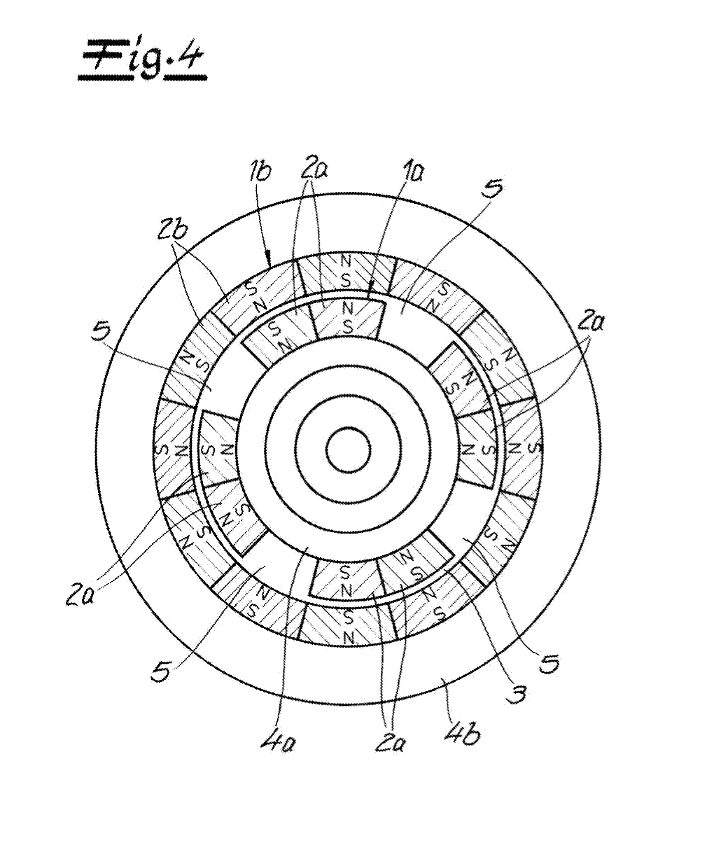

FIG. 4 shows an alternative embodiment of the invention in which intermediate spaces 5 are provided on the first rotor 1a—by way of example here the inner rotor —which intermediate spaces extend only over the angle of one permanent magnet 2a of the first rotor 1a. Based on the otherwise alternating orientation of the direction of magnetization, the directions of magnetization are therefore the same for both permanent magnets 2a flanking one of the intermediate spaces 5.

1. A permanent-magnet coupling for the synchronous transmission of rotary motion, comprising a first rotor and a second rotor that are each covered with permanent magnets and form an inner rotor and an outer rotor, permanent magnets associated with each other of the first rotor and of the second rotor extending across the same angle in the circumferential direction, wherein starting with complete coverage with permanent magnets in the circumferential direction on the first rotor, unfilled intermediate spaces are formed by omitting a portion of the permanent magnets, and that the first rotor and the second rotor have different numbers of permanent magnets.

2. The permanent-magnet coupling according to claim 1, wherein the second rotor is completely covered with permanent magnets in the circumferential direction.

3. The permanent-magnet coupling according to claim 1, that wherein the unfilled intermediate spaces on the first rotor are distributed angularly uniformly.

4. The permanent-magnet coupling according to claim 1, wherein successively arranged permanent magnets on the second rotor as viewed in the circumferential direction each have an opposite direction of magnetization.

5. The permanent-magnet coupling according to claim 1, wherein successively arranged permanent magnets on the first rotor as viewed in the circumferential direction each have an opposite direction of magnetization, the intermediate spaces each extending over an angle that corresponds to the angular dimension of two permanent magnets of the first rotor.

6. The permanent-magnet coupling according to claim 1, wherein permanent magnets flanking the intermediate spaces have the same direction of magnetization, the intermediate spaces each extending over an angle that corresponds to the angular dimension of a permanent magnet of the first rotor.

7. The permanent-magnet coupling according to claim 1, wherein two permanent magnets each with an opposite direction of magnetization are provided on the first rotor between two successively arranged intermediate spaces.

8. The permanent-magnet coupling according to claim 1, wherein the first rotor forms the inner rotor.

9. The permanent-magnet coupling according to claim 1, wherein the first rotor forms the outer rotor.

10. A permanent-magnet coupling comprising:
an inner support;
an outer support, the supports being rotatable relative to each other about an axis;
an annular first annular array centered on the axis of substantially identical and radially polarized first permanent magnets on one of the supports; and
an annular second annular array centered on the axis of substantially identical and radially polarized second permanent magnets on the other of the supports, the magnets of one of the arrays being of alternating polarity and being angularly spaced from each other by a dimension equal to substantially less than an angular width of the magnets of the one array, the other of the arrays being formed with a plurality of angularly equispaced magnet-free gaps each having an angular dimension equal to a whole-number multiple of that of the magnets of the other array.
